(19) United States
(12) Patent Application Publication
(10) Pub. No.: US 2021/0111958 A1
(43) Pub. Date: Apr. 15, 2021

(54) IDENTIFYING A PATH FOR INTERCONNECTING ENDPOINT RESOURCES TO CONSTRUCT LOGICAL SYSTEMS

(71) Applicant: HEWLETT PACKARD ENTERPRISE DEVELOPMENT LP, Houston, TX (US)

(72) Inventors: Nilakantan Mahadevan, Bangalore, IN (US); Russ W. Herrell, Ft. Collins, CO (US)

(21) Appl. No.: 16/598,484

(22) Filed: Oct. 10, 2019

(51) Int. Cl. H04L 12/24; G06F 13/40

(52) U.S. Cl. CPC H04L 41/0826; G06F 13/4027

(57) ABSTRACT

Examples may construct a logical system by interconnecting endpoint resources in a memory semantic environment. Examples include identifying a first path for interconnecting endpoint resources based on at least a cost for interconnecting the endpoint resources.

### BACKGROUND

A datacenter is a facility that provides computing services to an enterprise. In an example, a datacenter houses a variety of computer equipment and software applications used to provision the computing services as software-defined infrastructure. The computer equipment may include computers and servers, network equipment, storage equipment and the like. In some examples, the computer equipment in the datacenter may be managed by a management framework which may help in maintaining, controlling and arranging computer equipment for end use computing services for example, constructing logical systems.

### BRIEF DESCRIPTION OF THE DRAWINGS

For a more complete understanding of various examples, reference is now made to the following description taken in connection with the accompanying drawings in which the same numbers are used throughout the drawings to reference like features and components.

FIG. 1 illustrates an example computing environment including a plurality of computing systems and a management system;

FIG. 2 schematically illustrates an example of a fabric topology including various resources in a memory semantic environment;

FIG. 3 is a block diagram of an example of a management system;

FIG. 4 illustrates a block diagram of another example of a management system;

FIG. 5 is a flowchart of an example method including identifying a first path;

FIG. 6 is a block diagram of an example of a performance management system;

FIG. 7 schematically illustrates an example of a topology map for interconnecting resources in an example fabric topology; and

FIG. 8 is a flowchart of an example method including identifying a first path for interconnecting a requester to a responder.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. The term “and/or” as used herein refers to and encompasses any and all possible combinations of the associated listed items. As used herein, the term “includes” means includes but not limited to, the term “including” means including but not limited to.

As noted above, a management framework may maintain and control several resources (compute, network and storage resources) available at various equipment in a datacenter. A logical system may be composed, to implement a customer's plan, by selecting and interconnecting compute, network and storage resources appropriately. The storage resources may also include memory resources. In an example, a cost calculation for interconnecting the selected resources (that may be referred to as endpoint resources) may be provided for small scale environments that may include various resources within an enclosure or chassis. Furthermore, in some examples, a networking protocol for example, Open Shortest Path First (OSPF) and Border gateway Protocol (BGP) may provide a cost for network resources for example, switches. However, such network protocols do not include cost of combining compute and storage resources.

In some examples, several resources of a plurality of computing system for example, in a datacenter, may be communicatively coupled to one another over a memory semantic fabric. A memory semantic fabric may include an underlying memory media access. In an example, the memory semantic fabric may provide the CPU (Central processing unit)-memory byte-addressable load/store model extended to the entire system. Use of memory semantic fabric may enable high-speed and high bandwidth input/output (I/O) network that can connect processors to the physical media implementing main memory, at potentially significantly longer distances than otherwise possible. In such architecture, the memory access requests received by a memory controller from processing cores, may be transmitted to media controllers particularly to their attached physical media, over the fabric. That is, rather a memory controller have media access capability, the media-specific aspects of control may be moved from the memory controller to the media controller. An example standard governing such interconnection on a memory semantic fabric is Gen-Z.

Gen-Z is a universal scalable system interconnect that may be used to interconnect compute and storage resources, in a datacenter, through fabric switches (Gen-Z switches). Gen-Z uses a memory-semantic protocol that enables multiple resources of multiple computing systems to efficiently communicate. In a Gen-Z environment, compute and memory/storage resources may be available as fluid pools of resources. In such examples, a logical system may be composed by interconnecting one or more compute resources and one or more memory resources via fabric switches. However, in a large scale environment, as the number of resources increase, it may be challenging to select a combination of compute and storage resources via one or more switches, at any instant, to construct a logical system in a cost effective and highly efficient manner. That is, it is desirable to provide methods and systems that may enable selecting and interconnecting appropriate resources in a short duration and economic way such that the resources in the combination are highly efficient.

Examples of the present subject matter may provide methods and systems for identifying a first path for interconnecting two or more endpoint resources from a plurality of resources available in a memory semantic environment (for example, Gen-Z environment). In said example, the resources of the plurality of resources are coupled to one another over a memory semantic fabric. In an example, the present subject matter relates to systems and methods that provide a first path for interconnecting two or more endpoint resources based on at least a cost for interconnecting the endpoint resources. In an example, run-time updates to the first path may be made based on a change or a modification in at least one of the configuration of the plurality of resources and load characteristics (for example, bandwidth utilization and latency), at any instant of time, in the memory semantic environment.

As used herein, the term “resource”, refers to a compute resource, a network resource or a storage resource of a computing system. In an example, the network resource may include a switch. In an example, the plurality of resources comprise at least one of a compute resource, a storage resource and a network resource. For the sake of explanation, “resource” may also be referred to as “component” of a computing system, and these terms may be used interchangeably herein. As used herein, the term “endpoint resources” refers to at least one of a compute resource, a storage resource and a network resource that are selected to construct a logical system.

As used herein, the term “first path” refers to a path for interconnecting the endpoint resources, along which a cost for interconnecting the endpoint resources is a least value among the costs for interconnecting the endpoint resources along one or more paths. In some examples, the costs for interconnecting the endpoint resources along two or more paths may be same. In such examples, a first path from the two or more paths may be identified by applying a method of priority scheduling.

A logical system is an aggregation of at least a compute resource, a storage resource and a network resource for enabling a workload or application. In an example, a logical system may be a webserver, a database server, or an analytical engine. In an example, a logical system may be constructed by interconnecting, appropriately, at least one compute resource with at least one storage resource through at least one network resource (for example, a switch).

In an example, a method for identifying a first path for interconnecting two or more endpoint resources may be provided. In said example, the two or more endpoint resources may be selected from a plurality of resources of one or more computing systems. The resources of the plurality of resources may be connected to one another over a memory semantic fabric. The method may include providing a topology map representing one or more paths for interconnecting the two or more endpoint resources to construct a logical system; determining a cost for interconnecting the two or more endpoint resources corresponding each of the paths, and identifying a first path from the one or more paths based on at least a cost for interconnecting the two or more endpoint resources. In some examples, the first path may be identified from the one or more paths based on the cost for interconnecting the endpoint resources and load characteristics along the one or more paths. In an example, the load characteristic along a path may be determined based on a bandwidth utilization and latency along the path.

As used herein, the term “interconnecting” or “interconnect”, refers to connecting endpoint resources via a memory semantic protocol (for example, a Gen-Z protocol) to enable communication (for example, Gen-Z communication) among the endpoint resources. In an example, an information packet may be communicated between two endpoint resources on enabling such communication. In an example, the one or more network resources may be programmed to enable the memory semantic protocol to enable communication between two endpoint resources to interconnect them with each other.

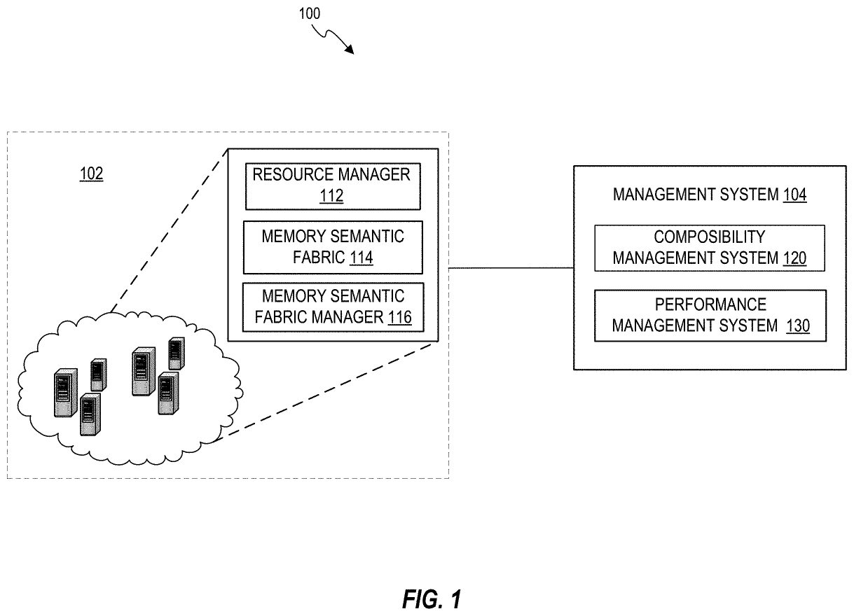

The systems and methods of the present subject matter are further described with reference to FIGS. 1-8. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and embodiments of the present subject matter, as well as specific examples thereof, are intended to encompass equivalents thereof.

FIG. 1 schematically illustrates a block diagram of an example computing environment 100 according to an example of the present subject matter. The computing environment may either be a public distributed environment or a private closed computing environment. In an example, the computing environment 100 may be a datacenter including a plurality of computing systems 102, each computing system may include various resources. In such example, the computing systems of the plurality of computing systems 102 may comprise a plurality of resources (not shown in FIG. 1). As illustrated in FIG. 1, the computing environment 100 may further include a management system 104 that maintains and controls functionalities of the plurality of computing systems 102. In an example, the management system 104 may include a composability management system 120 and a performance management system 130 coupled to the composability management system 120. The composability management system 120 may be an upper-layer management entity that manages and controls the plurality of resources. The performance management system 130 may be a lower-level management entity that assists the composability management system 120 in managing and controlling the plurality of resources. Each computing system 102, the composability management system 120 and the performance management system 130 may individually include processor(s) (not shown) to run an operating system, other applications or services. The processor(s) of each computing system 102, the processor(s) of the composability management system 120 and the processor(s) of the performance management system 130 may be utilized as microprocessor(s), microcomputer(s), microcontroller(s), digital signal processor(s), central processing unit(s), state machine(s), logic circuit(s), and/or any device(s) that manipulates signals based on operational instructions. Among other capabilities, each processor may fetch and execute computer-readable instructions stored in a memory. The functions of the various ‘processor(s)’ may be provided through the use of dedicated hardware as well as hardware capable of executing machine readable instructions.

As used herein, the term “computing system” may, for example, refer to a device including a processor, memory, and input/output interfaces for wired and/or wireless communication. In an example, the computing system may include a device including a non-volatile memory (NVM) module. The computing system may be machine readable instructions-based implementations, hardware-based implementations or combinations thereof. According to an example of the present subject matter, the computing systems 102 may include, but are not limited to, servers, workstations, computers, and the like. In an example, the computing systems 102 may include field-programmable gate array (FPGA) devices, complex programming logic devices (CPLDs), or other application specific integrated circuits (ASICs).

Computing systems of the plurality of computing systems 102 may communicate with different entities of the computing environment 100, such as the management system 104 through a network. The network may be a wireless network, a wired network, or a combination thereof. The network may also be an individual network or a collection of many such individual networks, interconnected with each other and functioning as a single large network, e.g., the Internet or an intranet. The network may be implemented as one of the different types of networks, such as intranet, local area network (LAN), wide area network (WAN), and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. In an example, the network may include a memory semantic protocol for example, Gen-Z protocol. In some examples, the network may further include a security protocol to ensure security and integrity in the memory semantic environment.

Depending on the implementation, the network may include various network entities, such as base stations, gateways and routers; however, such details have been omitted to maintain the brevity of the description. Further, it may be understood that the communication among various components and other entities may take place based on the protocol compatible with the network. In an example, two endpoint resources may be interconnected to enable communication between them via memory semantic protocol.

The plurality of resources of the plurality of computing systems 102 may include compute resources, network resources and storage resources. In the plurality of resources, each compute resource may act as a requester, each storage resource may act as a responder, and each network resource may interconnect at least one compute resource and at least one storage resource. In an example, the resources of the plurality of resources may be identified and managed by a resource manager 112. The resource manager 112 may have device information about each resource of the plurality of resources. In an example, the resources of the plurality of resources may be coupled to one another through the same network as discussed above. In an example of the present subject matter, the resources of the plurality of resources may be coupled to one another over a memory semantic fabric 114, and may be available as a pool of resources in the computing environment 100. In such example, the network may include a memory semantic protocol. Such computing environment 100 may include memory semantic network and be referred to as memory semantic environment.

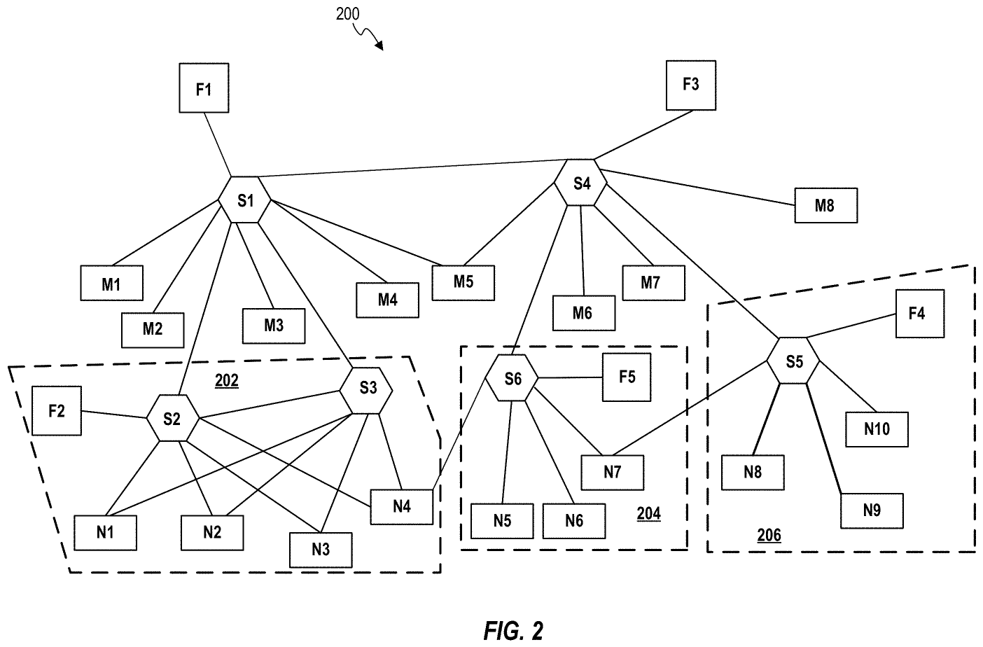

In an example, the computing environment 100 may further include one or more memory semantic fabric managers 116 that control a set of resources from the plurality of resources. In an example, the one or more fabric managers 116 may control logical abstractions between an endpoint resource and another endpoint resource while interconnecting the two or more endpoint resources. In examples as described herein, various components of the computing environment 100 such as the plurality of resources, the resource manager 112, the one or more fabric managers 116 and the management system 104, may be in communication with each other using an interface such as Redfish RESTful Application Programming Interface (API). Further, the resources in the pool of resources and the one or more fabric managers 116 may be arranged to form a fabric topology (described below with reference to FIG. 2) in the memory semantic environment.

The term “topology” may refer to a geometrical/structural representation of the arrangement of various components in a network. As used herein, the term “fabric topology” refers to a geometrical/structural representation of the arrangement of various resources in memory semantic environment.

For example, FIG. 2 schematically shows an example of a fabric topology 200 in a memory semantic environment that includes eight requesters ‘Mi’, where j=1, 2, 3, . . . 8 (M1, M2, M3, . . . M8), ten responders ‘Nj’, where j=1, 2, 3, . . . 10 (N1, N2, . . . N10) and six switches ‘Sk’, where k=1, 2, 3, . . . 6 (S1, S2, . . . S6) for interconnecting the requesters ‘Mi’ to the responders ‘Nj’. At least one requester ‘Mi’ may be coupled to at least one responder ‘Nj’ through at least one switch ‘Sk’. In such examples, the at least one switch ‘Sk’ may enable memory semantic protocol to interconnect the at least one requester ‘Mi’ and the at least one responder ‘Nj’ to construct a logical system. In the illustrated example, the fabric topology 200 may include five fabric managers ‘Fl’, where l=1, 2, 3, . . . 5 (F1, F2, . . . F5). Each fabric manager ‘Fl’ may be coupled to at least one switch ‘Sk’. For example, as illustrated in FIG. 4, fabric manager F1 is coupled to switch S1, F2 is coupled to S2 and S3, F3 is coupled to S4, F4 is coupled to S5, and F5 is coupled to S6. The fabric topology 200 may be segmented into a plurality of zones depending on physical locations of various resources (i.e., Mi and Nj). Each zone may include at least one fabric manager ‘Fl’, one or more switches ‘Sk’, one or more requesters ‘Mi’, and one or more responders ‘Nj’. For example, FIG. 2 shows three zones (202, 204 and 206) in the fabric topology 200. Although FIG. 2 here shows three example zones in the fabric topology 200, the fabric topology 200 may include more zones. In some other examples, a memory semantic environment may be divided into several zones depending on the size of the environment.

Referring to FIG. 1, the composability management system 120 may be responsible for controlling and maintaining the functionalities of the resources of the plurality of resources. In an example, the composability management system 120 may be pre-configured with the configurations of the resources of the plurality of resources. In said examples, the composability management system 120 may be responsible for the overall arrangement of the resources in the memory semantic environment and controls the plan for interconnecting two or more endpoint resources for constructing logical systems. In an example, the interconnecting two or more endpoint resources may be performed by the composability management system 120 through one or more fabric managers 116. In some example, the composability management system 120 may further be responsible for enforcing security policies for arranging and interconnecting the resources.

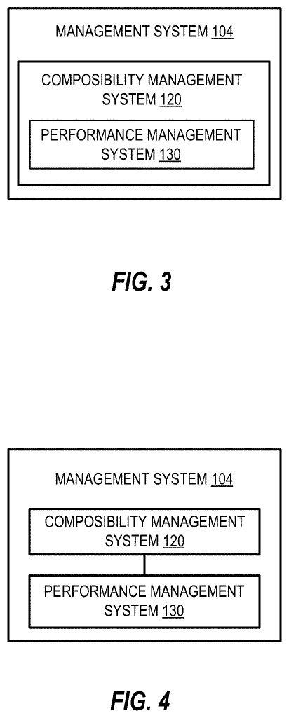

In an example of the present subject matter, the performance management system 130 may be a management entity that identifies a first path to interconnect two or more endpoint resources based on at least a cost for interconnecting the endpoint resources to construct a logical system. In some examples, the performance management system 130 provides information of the first path to the composability management system 120, which manages interconnecting the two or more endpoint resources along the first path. In an example, the performance management system 130 may be a part of the composability management system 120, as illustrated in FIG. 3. In another example, the performance management system 130 may exist external to the composability management system 120, as illustrated in FIG. 4.

In some examples, the performance management system 130 may maintain the fabric topology and determine two or more endpoint resources from the plurality of resources. In some other examples, the composability management system 120 may determine the two or more endpoint resources from the plurality of resources and provide the information to the performance management system 130 to determine the first path for interconnecting the two or more endpoint resources. The identification of appropriate endpoint resources may be made based on one or more parameters such as device information of the resources, availability of the resources, physical location of the resources, and bandwidth and latency along a path to interconnect the endpoint resources.

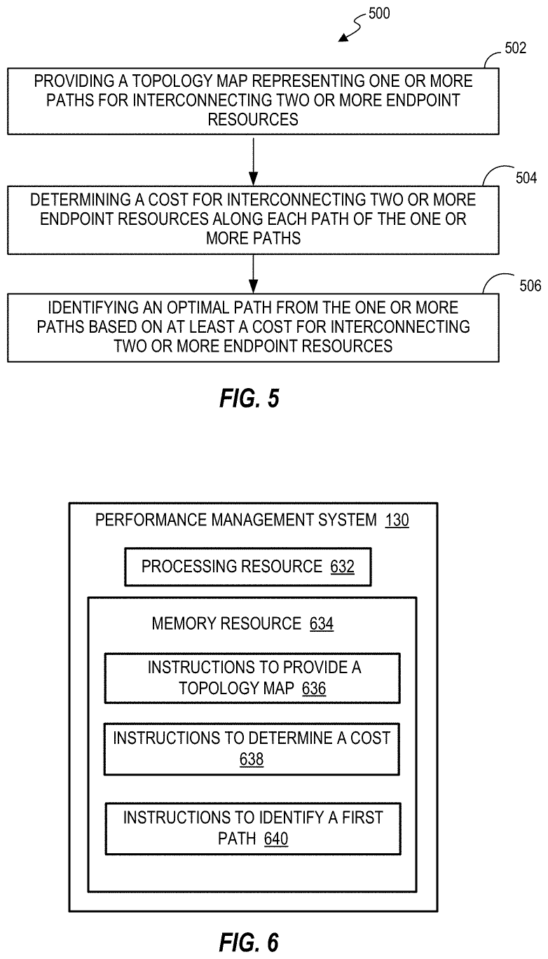

In an example, the performance management system 130 may provide a topology map representing one or more paths for interconnecting the two or more endpoint resources. In such example, the determination of the first path may be achieved based on at least a cost for interconnecting the two or more endpoint resources along the first path. In some examples, the determination of the first path from one or more paths may be achieved by determining the cost and the load characteristics along each path for interconnecting the two or more endpoint resources. In such examples, a cost for interconnecting the two or more endpoint resources may include any cost applicable due to the load characteristics along each of the paths. In some examples, the determination of the first path may further be achieved by applying a method of priority scheduling (discussed below), when the costs along two or more paths may be same. The process of determining the first path for interconnecting two or more endpoint resources is described below in detail with respect to FIGS. 5 and 6.

FIG. 5 is a flowchart of an example method 500 for identifying a first path for interconnecting two or more endpoint resources to construct a logical system. In an example, the method 500 is performed by the performance management system 130. In an example, FIG. 6 is a block diagram of the performance management system 130. As illustrated in FIG. 6, the performance management system 130 includes a processing resource 632 and a machine readable storage medium 634 comprising (e.g., encoded with) at least instructions 636, 638, and 640 that are executable by the processing resource 632 of the performance management system 130 to implement functionalities described herein in relation to instructions 636, 638 and 640.

The execution of method 500, is described in details below with reference to FIGS. 5 and 6. Although the below description is described with reference to the performance management system 130 of FIG. 6, however other computing devices suitable for the execution of method 500 may be utilized. Additionally, implementation of method 500 is not limited to such examples. Although the flowchart of FIG. 5 shows a specific order of performance of certain functionalities, method 500 is not limited to that order. For example, the functionalities shown in succession in the flowchart may be performed in a different order, may be executed concurrently or with partial concurrence, or a combination thereof.

In an example, the method blocks of the method 500 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media.

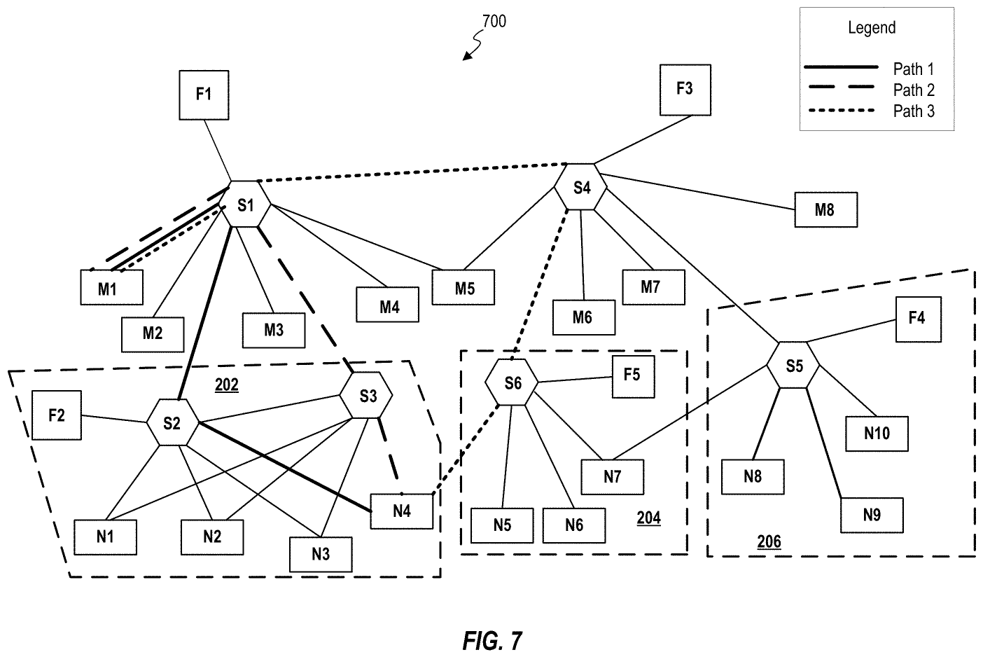

At 502 of the method 500 (FIG. 5), instruction 636 of the performance management system 130 of FIG. 6, may (e.g., when executed by the processing resource 632) provide a topology map that represents one or more paths for interconnecting the two or more endpoint resources from the plurality of resources to construct a logical system. In other words, the topology map represents various ways to interconnect the two or more endpoint resources to one another. In an example, the topology map is created in the fabric topology by providing one or more paths to interconnect the two or more endpoint resources. For example, FIG. 7 shows an example of a topology map 700 representing Path 1, Path 2 and Path 3 for interconnecting endpoint resources M1 and N4 that may be determined from the fabric topology of the memory semantic environment in FIG. 4. In some examples, a topology map may be created for interconnecting several combination of resources. In some examples, a topology map may be created for interconnecting a requester to each responder along various paths in a fabric topology.

The method 500 may further include selecting the two or more endpoint resources for constructing the logical system. In some examples, the selecting the two or more endpoint resources may include retrieving inventory information of the resources of the plurality of resources and selecting the two or more endpoint resources based on the inventory information. In such examples, the inventory information may be retrieved from the resource manager 112. In an example, the selection of the two or more endpoint resources may be performed by the performance management system 130. In such examples, the performance management system 130 may further retrieve inventory information of the resources of the plurality of resources and selecting the two or more endpoint resources based on the inventory information. The inventory information may include device information of the resources such as type of resources and capacity of resources, availability of the resources, physical location of the resources, bandwidth and latency along a path to interconnect the resources, and the like. Based on such information of resources of the plurality of resources, the two or more endpoint resources may be selected from the resources for constructing the logical system. In another example, the two or more endpoint resources may be selected by the composability management system 120; and this information may be provided to the performance management system 130. After determining the two or more endpoint resources, the performance management system 130 may create the topology map that represents one or more paths for interconnecting the two or more endpoint resources.

At 504 of the method 500, instruction 638 may provide a cost matrix by determining a cost for interconnecting the two or more endpoint resources along each of the paths. In an example, the cost for interconnecting the two or more endpoint resources may include a cost ‘A’ for interconnecting at least one network resource along each of the paths from the network resource cost matrix and another cost ‘B’ for interconnecting a requester, a responder or both to the at least one network resource along each of the paths. In an example, each cost ‘A’ and cost ‘B’ may include any cost involved for respective interconnection for example, a cost corresponding to one or more of bandwidth utilization and latency along each of the paths. The cost matrix may represent a first cost for interconnecting the two or more endpoint resources. A first cost may be a least value among the costs for interconnecting a requester and a responder along the one or more paths according to the topology map. In such example, the first cost is the cost for interconnecting the two or more endpoint resources along a first path. In an example, the cost matrix may be provided by identifying the first cost among the costs for interconnecting the two or more endpoint resources along the one or more paths. In an example, instruction 638 may determine a cost for interconnecting a requester and a responder along each of the paths and identify a first cost among the costs along each of the paths. In an example, a first cost for interconnecting each requester and each responder may be determined. In some examples, instruction 638 may provide a cost matrix that represents a first cost for interconnecting a requester and a responder in the fabric topology. Prior to creating the cost matrix, the instruction 638 may further create a network resource cost matrix. The network resource cost matrix may include cost for interconnecting at least one network resource (for example, a switch) along each of the paths based on the fabric topology. Table 1 shows an example of a network resource cost matrix created based on the fabric topology 200 of FIG. 2. The cost matrix may provide the first cost for interconnecting each pair of resources (i.e., each requester to each responder) via at least one network resource. Table 2 shows an example of a cost matrix created based on the fabric topology 200 of FIG. 2 and the network resource matrix as shown in Table 1.

At 506 of the method 500, instruction 640 may identify a first path from the one or more paths based on at least the cost for interconnecting the two or more endpoint resources along the first path. In an example, the first path is a path along which the first cost for interconnecting the two or more endpoint resources is represented in the cost matrix. In an example, instruction 640 may provide a path matrix based on the cost matrix. The path matrix may represent first paths for interconnecting two resources i.e. a requester and a responder, in the fabric topology, based on the first cost represented in the cost matrix. In an example, the first path for interconnecting the two or more endpoint resources from the one or more paths as shown in the topology map may be identified based on the first cost for interconnecting two or more endpoint resources in the cost matrix.

The instructions 636-640 may include various instructions to execute at least a part of method 500 described with reference to FIG. 5. Also, although not shown in FIG. 6, the machine readable medium 634 may also include additional program instructions to perform various other method blocks described with reference to FIG. 5. Further, the foregoing method 500 may be executed based on instructions 636, 638, 640 that may be performed simultaneously or sequentially. In some examples, instructions 638 and 640 may be performed simultaneously.

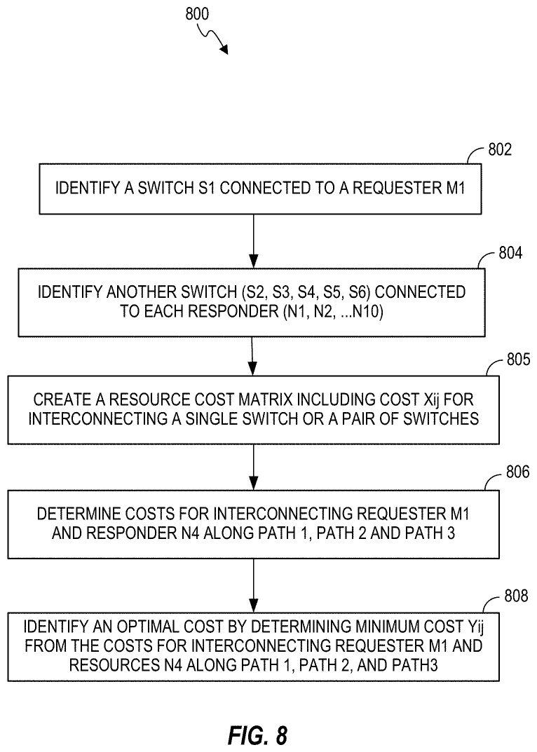

FIG. 8 is a flowchart for an example method 800 of identifying a first path for interconnecting requester M1 and responder N4 in the fabric topology 200 of FIG. 2. FIG. 7 represents the topology map 700 that shows Path 1, Path 2, and Path 3 for interconnecting requester M1 and responder N4. In an example, the method 800 may include providing a cost matrix of Table 2 and a path matrix of Table 3 for the fabric topology 200 shown in FIG. 2 for identifying the first path. In 802, the method 800 may include identifying a switch S1 coupled to requester M1. In 804, the method may include identifying switches (S2, S3, S4, S5, S6) coupled to each responder (N1, N2, . . . N10). At 805, the method 800 may provide a network resource cost matrix as shown in Table 1 that represents costs corresponding a single switch or a pair of switches in the fabric topology 200 along various paths for interconnecting each requester to every responder. In the network resource cost matrix of Table 1, Xij shows a cost for interconnecting a pair of switches ‘Si’ and ‘Sj’ where 1=1, 2, 3, . . . 6 and j=1, 2, 3, . . . 6. In Table 1, X11, X22, X33, X44, X55 and X66, each represents a cost for interconnecting respective single switch along a path.

TABLE 1
Network resource cost matrix

| Switch | S1 | S2 | S3 | S4 | S5 | S6 |
|---|---|---|---|---|---|---|
| S1 | X11 | X12 | X13 | X14 | X15 | X16 |
| S2 | X21 | X22 | X23 | X24 | X25 | X26 |
| S3 | X31 | X32 | X33 | X34 | X35 | X36 |
| S4 | X41 | X42 | X43 | X44 | X45 | X46 |
| S5 | X51 | X52 | X53 | X54 | X55 | X56 |
| S6 | X61 | X62 | X63 | X64 | X65 | X66 |

In 806, the method 800 may include determining costs for interconnecting requester M1 to responder N4 along Path 1, Path 2, and Path 3. The costs may be determined by calculating costs for interconnecting each requester (M1, M2, . . . M8) to every responder (N1, N2, . . . N10) along one or more paths that include one or more switches. For example, for interconnecting M1 and N4, the method 800 may calculate costs for interconnecting requester M1 and responder N4 along Path 1, Path 2, and Path 3. The cost for interconnecting requester M1 and responder N4 along each path may include a first cost for interconnecting M1 to S1 and N4 to S3 and a second cost for interconnecting, respectively, S1 and S2 (Path 1), S1 and S3 (Path 2) or S1, S4, and S6 (Path 3) from the network resource cost matrix of Table 1. The method 800 may further include repeating the above steps for calculating costs for interconnecting requesters (M2, M3, . . . M8) to each responder (N1, N2, . . . N10) along one or more paths. In 808, the method 800 may include identifying a first cost by determining a least value among costs for interconnecting requester M1 and responder N4 along one or more paths. In 808, the method 800 may determine least values of costs for interconnecting each requester to every responder in the fabric topology 200 of FIG. 2 and provide a cost matrix as shown in Table 2 that represents a first cost (Yij, where i represents the requesters and j represents responders) for interconnecting a requester and a responder in the fabric topology 200.

In Table 2, Yij represents a first cost for interconnecting Mi and Nj in the fabric topology 200 in FIG. 2. In an example, a first cost Y41 for interconnecting requester M1 and responder N4 along Path 1 is a least value among the costs along Path 1, Path 2, and Path 3. In such example, the first cost Y41 is a least value because the cost X13 for interconnecting S1 and S3 along Path 2 and the cost (a combined cost of X14 and X46) for interconnecting 51, S4, and S6 along Path 3 according to table are higher than the cost X12 for interconnecting S1 and S2 along Path 1.

TABLE 2
Cost matrix

| Resources | M1 | M2 | M3 | . . . | M8 |
|---|---|---|---|---|---|
| N1 | Y11 | Y12 | Y13 | . . . | Y18 |
| N2 | Y21 | Y22 | Y23 | . . . | Y28 |
| N3 | Y31 | Y32 | Y33 | . . . | Y38 |
| N4 | Y41 | Y42 | Y43 | . . . | Y48 |
| . . . | . . . | . . . | . . . | . . . | . . . |
| N10 | Y101 | Y102 | . . . | . . . | Y108 |

The method 800 further provides a path matrix as shown in Table 3 below based on the cost matrix in Table 2. Table 3 represents intervening switches along the first paths, for interconnecting requesters (M1, M2, . . . M8) to responders (N1, N2, . . . N10), corresponding to the first costs represented in the cost matrix of Table 2. For example, Table 2 shows the first cost Y41 for interconnecting requester M1 and responder N4. The first cost Y41 is the cost along Path 1 and is lesser than that of the costs along Path 2 and Path 3. Hence, Path 1 is the first path for interconnecting requester M1 and responder N4. Accordingly, the path matrix in Table 3 shows Path 1 that includes intervening switches S1 and S2 for interconnecting requester M1 and responder N4 as the first path.

TABLE 3
Path matrix

| Resource | M1 | M2 | M3 | . . . | M8 |
|---|---|---|---|---|---|
| N1 | . . . | . . . | . . . | . . . | . . . |
| N2 | . . . | . . . | . . . | . . . | . . . |
| N3 | . . . | . . . | . . . | . . . | . . . |
| N4 | S1, S2 | . . . | . . . | . . . | . . . |
| . . . | . . . | . . . | . . . | . . . | . . . |
| N10 | . . . | . . . | . . . | . . . | . . . |

In another example, the path matrix may be a three dimensional array, which may include a first path corresponding to a first cost that is a least value, a second path corresponding to a cost that is more than the first cost and lower than the other costs along the one or more paths. In one example, the path matrix may represent a plurality of paths in increasing order of the cost for interconnecting the endpoint resources along the paths. Such path matrix may provide a simple and easy look up for selecting a desired path, in some examples.

In some example, the method 500 may further include interconnecting the two or more endpoint resources along a first path after identifying the first path for interconnecting the two or more endpoint resources from the path matrix. In an example, the interconnecting the endpoint resources along the first path may be performed by the composability management system 120. The performance management system 130 may provide the path matrix to the composability management system 120, which may enable interconnecting two or more endpoint resources by identifying the first path from the path matrix. In an example, the composability management system 120 may enable interconnecting two or more endpoint resources via the one or more fabric managers 116.

In an example, the method 500 may further include updating the cost matrix based on a run-time parameter. In an example, the processing resource of the performance management system 130 is to update the cost matrix based on a run-time parameter. As used herein, the term “run-time parameter” refers to a parameter or a feature that changes while a program or an operation is running. In an example, a run-time parameter may be a run-time change in the configuration of the fabric topology or topology map. A run-time change in the configuration of the fabric topology or topology map may occur due to a change in resources of the fabric topology, a change in load characteristics in the fabric topology, or based on Quality of Service (QoS) goals and admin policies. In an example, a change in resources of the fabric topology may be a result of the selection of at least one endpoint resource that is different from the two or more endpoint resources identified previously, a change in the fabric topology due to the addition of a new path or both. A change in load characteristics may be a result of a change in bandwidth utilization or latency along a path in the fabric topology. QoS goals and admin policies may involve a desired bandwidth for interconnecting two or more endpoint resources. A change in topology map may occur to maintain desired bandwidth for interconnecting two or more endpoint resources according to QoS goals and admin policies. In an example, the process of providing the cost matrix may be repeated to update the cost matrix based on the run-time parameter. As a result, an updated cost matrix may be provided. In an example, the process of creating the path matrix may be repeated to update the path matrix based on the updated cost matrix, and may provide an updated path matrix based on the updated cost matrix. Accordingly, an updated first path may be identified based on the updated cost matrix and the updated path matrix by using the process of identifying a first path as described above. In other words, run-time updates to the first path may be made based on the run-time parameter.

In some examples, the management system 130 may further include instructions to cause the processing resource 632 to apply a method of priority scheduling when the costs along two or more paths are same. The method of priority scheduling may include a round robin method to prioritize a path from two or more paths along which the costs for interconnecting two or more endpoint resources are equal. This method may provide resiliency by prioritizing a path from two or more paths. In such examples, a first path for interconnecting two or more endpoint resources may be identified from two or more paths (along which the costs for interconnecting two or more endpoint resources are equal) by a round robin method.

As discussed herein, the present subject matter enables to dynamically enlarge a memory semantic environment for example, Gen-Z environment that includes a population of resources (requesters and responders) and provide scalability in a data center using the memory semantic interconnect. The present subject matter provides methods and systems for maintaining and controlling various resources, in a Gen-Z environment, for providing logical systems that are cost effective and highly efficient. The cost matrix and the path matrix, as described above, enables quick recognition and prioritization of redundant and resilient paths, and selection of first paths for constructing logical systems. The described systems and methods provide several advantages in identifying appropriate combinations of resources based on costs for interconnecting the resources and load characteristics. In addition, the present methods and systems use dynamically updated cost matrix to equally distributing the traffic load across the environment at any point in time. For example, run-time updates to the cost matrix can trigger dynamic changes to routing options for existing and new logical systems, based on QoS goals and admin policies. Further, multiple paths with similar cost functions can be assigned across multiple logical systems to keep utilization levels similar across the environment based on instantaneous conditions. Thus, the present subject matter provides intelligence for controlling, maintaining and monitoring performance of both the environment including the resources and logical systems accessing the environment.

Various examples described herein are described in the general context of method steps or processes, which may be implemented, in an example, by a software program product or component, embodied in a machine-readable medium, including executable instructions, such as program code, executed by entities in networked environments. Generally, program modules may include routines, programs, objects, components, data structures, etc. which may be designed to perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

1. A method, comprising:
providing, by a performance management system, a topology map including one or more paths for interconnecting two or more endpoint resources to construct a logical system, wherein the two or more endpoint resources are coupled to one another over a memory semantic fabric;
determining, by the performance management system, a cost for interconnecting the two or more endpoint resources along each of the paths; and
identifying, by the performance management system, a first path from the one or more paths based on the cost for interconnecting the two or more endpoint resources and load characteristics along each of the paths.

2. The method of claim 1, further comprising identifying the two or more endpoint resources from a plurality of resources of one or more computing systems, wherein the plurality of resources are coupled to one another over the memory semantic fabric.

3. The method of claim 2, wherein the plurality of resources comprise at least one of a compute resource, a storage resource and a network resource.

4. The method of claim 2, wherein the identifying comprises identifying the two or more endpoint resources based on inventory information of the plurality of resources.

5. The method of claim 1, wherein the identifying the first path comprises identifying the first path from a cost matrix that includes a first cost for interconnecting the two or more endpoint resources along the first path.

6. The method of claim 5, wherein the first cost is a cost along the first path, that is a least value among the costs for interconnecting the two or more endpoint resources along the one or more paths.

7. The method of claim 1, wherein the identifying the first path comprises identifying the first path, from the one or more paths, along which the cost for interconnecting the two or more endpoint resources is a least value.

8. (canceled)

9. The method of claim 1, further comprising interconnecting, by a composability management system, the two or more endpoint resources along the first path after identifying the first path by the performance management system.

10. A non-transitory processor readable medium comprising instructions executable by at least one processing resource to:
provide a topology map including one or more paths for interconnecting two or more endpoint resources to construct a logical system, wherein the two or more endpoint resources are coupled to one another over a memory semantic fabric;
provide a cost matrix by determining a cost for interconnecting the two or more endpoint resources along each of the paths; and
identify a first path from the one or more paths based on the cost for interconnecting the two or more endpoint resources and load characteristics along each of the paths.

11. The non-transitory processor readable medium of claim 10, further comprising instructions to identify the two or more endpoint resources from a plurality of resources of one or more computing systems, wherein the plurality of resources are coupled to one another over the memory semantic fabric.

12. The non-transitory processor readable medium of claim 11, wherein the plurality of resources comprise at least one of a compute resource, a storage resource, and a network resource.

13. The non-transitory processor readable medium of claim 11, further comprising instructions to identify the two or more endpoint resources from the plurality of resources based on inventory information of the plurality of resources.

14. The non-transitory processor readable medium of claim 10, wherein the cost matrix comprises a first cost for interconnecting the two or more endpoint resources along the first path.

15. The non-transitory processor readable medium of claim 14, wherein the first cost is a cost along the first path, that is a least value among the costs for interconnecting the two or more endpoint resources along the one or more paths.

16. The non-transitory processor readable medium of claim 10, wherein the first path is identified by determining a path from the one or more paths along which the cost for interconnecting the two or more endpoint resources is a least value.

17. (canceled)

18. The non-transitory processor readable medium of claim 10, further comprising instructions to cause the processing resource to update the cost matrix based on a run-time parameter.

19. The non-transitory processor readable medium of claim 10, further comprising instructions to cause the processing resource to apply a method of priority scheduling when the costs for interconnecting the two or more endpoint resources along two or more paths are same.

20. A performance management system comprising:
a processing resource; and
a non-transitory machine-readable storage medium comprising instructions executable by at least one processing resource to:
provide a topology map including one or more paths for interconnecting two or more endpoint resources to construct a logical system, wherein the two or more endpoint resources are coupled to one another over a memory semantic fabric;
provide a cost matrix by determining a cost for interconnecting the two or more endpoint resources along each of the paths; and
identify a first path from the one or more paths based on the cost for interconnecting the two or more endpoint resources and load characteristics along each of the paths.

21. The method of claim 1, wherein the two or more endpoint resources comprise a compute resource and a storage resource, and
the cost for interconnecting the compute resource to the storage resource along each of the paths comprises a cost for interconnecting at least one network resource along each of the paths and another cost for interconnecting the compute resource and the storage resource or both to the at least one network resource along each of the paths.

22. The method of claim 1, wherein the load characteristics along each of the paths are determined based on bandwidth utilization or latency along that path at a point in time.
